(19) United States
(12) Patent Application Publication
(10) Pub. No.: US 2007/0230349 A1
(43) Pub. Date: Oct. 4, 2007

(54) ADJUSTMENT OF THE NUMBER OF BURST FRAMES TRANSMITTED OVER WIRELESS NETWORK

(76) Inventor: Hung-Yi Chen, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/692,985

(22) Filed: Mar. 29, 2007

(30) Foreign Application Priority Data
Mar. 31, 2006 (TW) 095111353

(51) Int. Cl. H04J 1/16; H04J 3/22

(52) U.S. Cl. 370/235; 370/468

(57) ABSTRACT

The invention relates to a system and a method for adjusting the number of burst frame transmitted through a channel from a transmitting device to a receiving device, wherein the number of burst frame is predetermined. A parameter associated with the frames received is first calculated, and then compared with a first threshold and a second threshold to provide comparison results for add or reduce the number of burst frames.

### BACKGROUND OF THE INVENTION

1. Field of the Invention

The present invention relates to a communication system and a method for adjusting the number of burst frames transmitted through a channel from a transmitting device to a receiving device, and the system and method, in particular, can be applied to a wireless network.

2. Description of the Prior Art

As the demand for wireless networks in close distances continues to increase, the Wireless Personal Area Network (WPAN) has penetrated deeply into people's daily lives. The WPAN technology is suitable for wireless transmission from personal peripheral devices, and especially to be applicable to Personal Operating Space (POS) within 10 meters through a mobile, personal arithmetic unit network built on low power and low cost wireless transmission.

The purpose of the Media Access Control (MAC) layer in the WPAN is to ensure that information can be transmitted both reliably and securely through the physical layer. In the transmission process, the data from the upper layers is received by the MAC layer and is subsequently divided into many frames for transmission. Because transmission of data through wireless network is error-prone, an acknowledgement is needed to send from the receiving end to inform the transmitting end to carry out the retransmission mechanism to ensure transmission quality.

There are three types of acknowledgment mechanisms currently used in wireless networks: no acknowledgement mechanism (please refer to FIG. 1A), an automatic response in the form of an acknowledgement (please refer to FIG. 1B), which is sent for each frame received at the receiving end, and the burst acknowledgement mechanism (please refer to FIG. 1C). In the burst acknowledgement mechanism, a transmitting device continuously transmits a predetermined number of burst frames to a receiving device which will transmit back a burst acknowledgment notifying the correctly received information from the predetermined number of frames, upon reception of a transmitted frame containing information requesting for an acknowledgment.

On the other hand, the next set of burst frames are only transmitted after an acknowledgement is received by the transmitting end. Because frames received are transmitted sequentially in the network application programs of upper layers, the ones with numbers not in sequence will be stored in the buffer of the receiving device.

However, the number of times that the transmitting end retransmits frames previously incorrectly received increases when the condition of the transmitting channel is poor. When the number of burst frames is not adjusted accordingly, it will cause a low usage rate of the transmitting channel and an inefficient communication system.

Accordingly, the scope of the present invention is to provide a communication system and a method for adjusting the number of burst frames to solve the aforementioned problems.

### SUMMARY OF THE INVENTION

To solve the aforementioned problems, the scope of the invention is to provide a communication system and a method for adjusting the predetermined number of burst frames which are transmitted through a channel from a transmitting device to a receiving device.

A preferred embodiment of the invention provides a method for adjusting the number of frames which are transmitted through a channel from a transmitting device to a receiving device. The method first calculates a parameter associated with the frames received during the reception of the burst frames, and then it compares the parameter with a first threshold to obtain a comparison result for adjusting the predetermined number of burst frames. If the parameter is greater than the first threshold, the predetermined number is reduced by a first value, whereas if the parameter is equal to or smaller than the first threshold, the predetermined number is maintained the same. Then, the parameter is compared with a second threshold. If the parameter is smaller than the second threshold in the subsequent comparison, the predetermined number is adjusted by adding a second value to it.

Another preferred embodiment of the invention provides a communication system comprising a transmitting device and a receiving device, and it is used for adjusting the number of burst frames. The transmitting device transmits a predetermined number of burst frames, whereas the receiving device receives those burst frames and calculates, during reception, a parameter associated with the frames received. An acknowledgement will then be sent out by the receiving device at the end of the reception process to the transmitting device for adjusting the predetermined number of burst frames according to the parameter from the acknowledgement. First, during the reception of burst frames, a parameter associated with the frames received is calculated. The parameter is then compared with the first threshold to yield a comparison result for adjusting the predetermined number of burst frames. A first value is subtracted from the predetermined number if the parameter is greater than the first threshold, whereas the number is maintained the same if the parameter is equal to or smaller than the first threshold. The parameter is subsequently compared with the second threshold, and a second factor is added to the predetermined number if the parameter is smaller than the second threshold.

The advantage and spirit of the invention may be understood by the following recitations together with the appended drawings.

### BRIEF DESCRIPTION OF THE APPENDED DRAWINGS

FIG. 1A is a diagram illustrating the no acknowledgement mechanism used in wireless network;

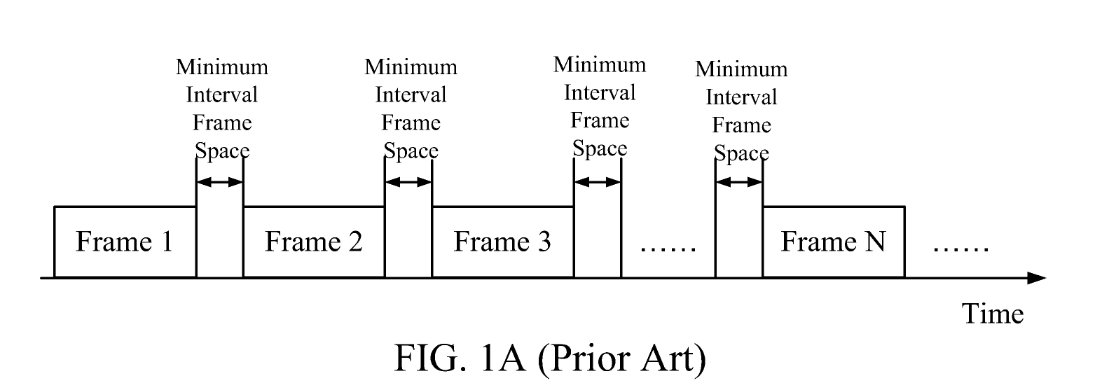

FIG. 1B is a diagram illustrating the automatic response acknowledgement mechanism used in wireless network;

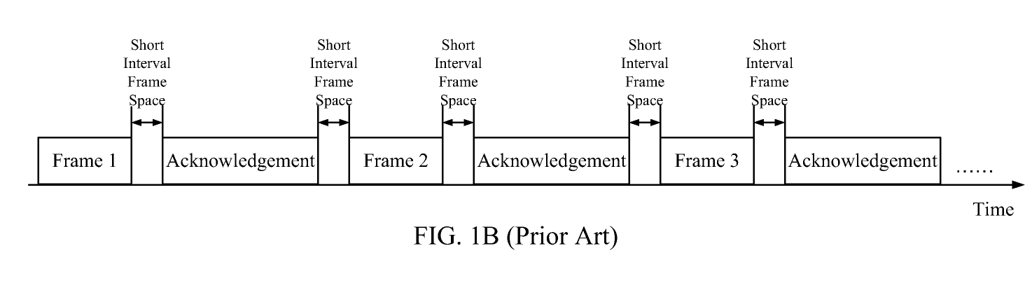

FIG. 1C is a diagram illustrating the burst acknowledgement mechanism used in wireless network;

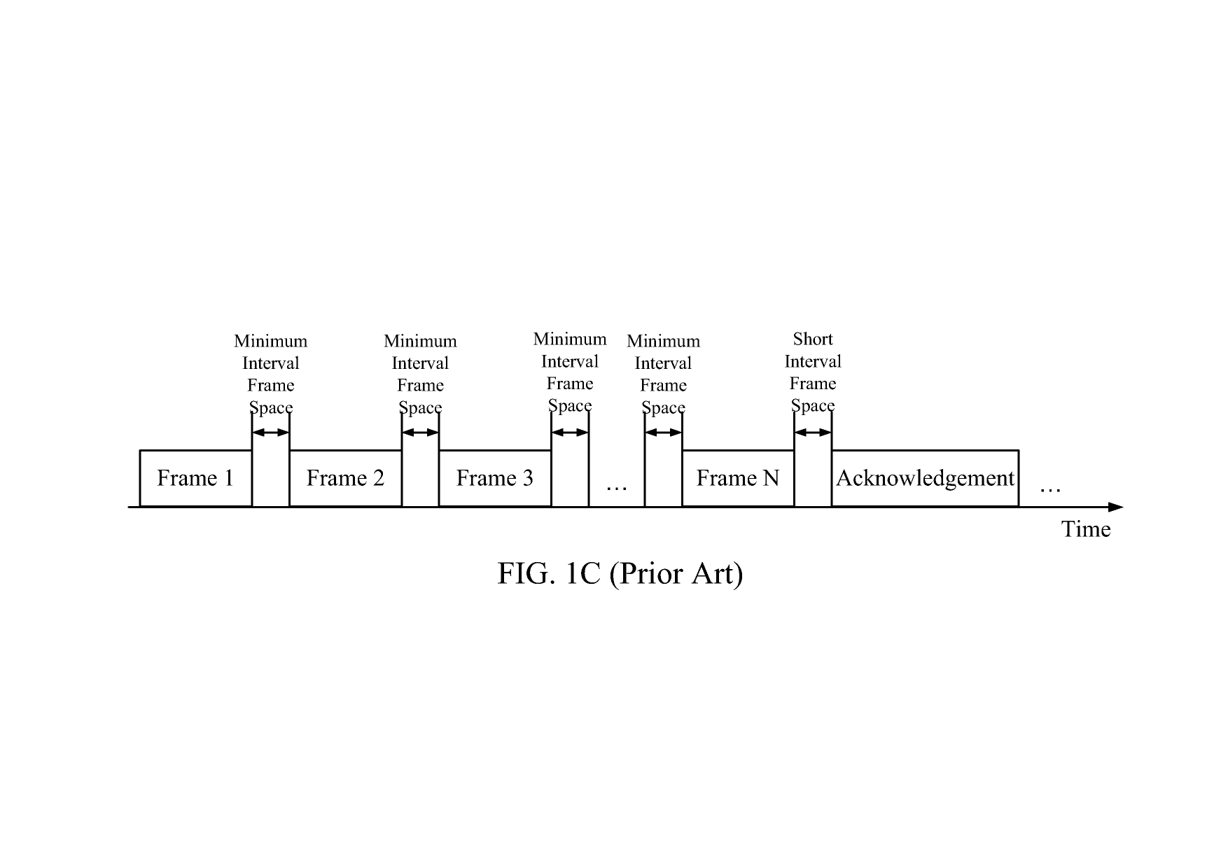

FIG. 2 is a flowchart showing the operating flow of the adjustment of the number of burst frames according to the first preferred embodiment of the invention;

FIG. 3 is a schematic diagram illustrating the communication system according to the second preferred embodiment of the invention;

FIG. 4A is a flowchart showing the operating flow of the adjustment of the number of burst frames in communication systems according to the second preferred embodiment of the invention; and

FIG. 4B is a flowchart showing the operating flow of adjustment of the name of burst frames in communication systems according to the second preferred embodiment of the invention.

### DETAILED DESCRIPTION OF THE INVENTION

The scope of the invention is to provide a communication system and a method for adjusting the predetermined number of burst frames which are transmitted through a channel from a transmitting device to a receiving device.

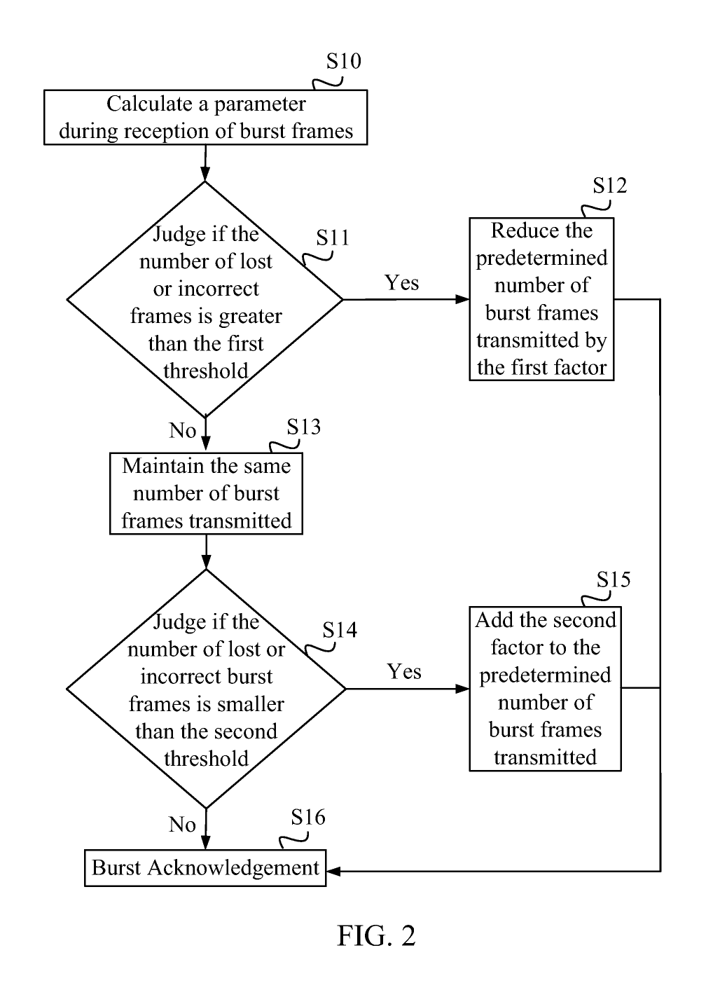

Referring to FIG. 2, FIG. 2 is a flowchart showing the operating flow of the adjustment of the number of burst frames, according to a preferred embodiment of the invention. The method first carries out step S10 to calculate, during reception, a parameter associated with the frames received.

In another embodiment of the method, the parameter is associated with the number of frames lost during transmission. For example, twenty out of an initial one hundred frames transmitted represent lost frames, which cannot be decoded at the receiving end, due to noisy transmission or long distance.

In another embodiment of the method, the parameter is associated with the number of incorrect frames among the received frames. Incorrect frames are defined as frames which can be decoded at the receiving end, but their contents are deemed wrong by checking error detection codes.

In another embodiment of the method, the receiving device has a buffer for storing the correctly received frames, which have serial numbers to indicate the order of transmission, and for sending the frames to upper layers of the software for information processing after successive receptions are completed. However, frames not received in order are also stored in the buffer to await the retransmitted frames if some of the frames are not received, and in this case, the parameter is associated with the number of frames stored in the buffer.

Step S11 is carried out to judge whether the number of lost or incorrect frames is greater than the first threshold. Step S12 is carried out to reduce the predetermined number of burst frames by the first factor if the comparison result shows that the parameter is greater than the first threshold, whereas step S13 is performed to maintain the same predetermined number if result indicates an equal or a relatively smaller parameter value. In following, step S14 is performed to judge whether the number of lost or incorrect frames is smaller than the second threshold, and the second factor is added to the number of frames in step S15 if the comparison result indicates a relatively smaller parameter value. Upon completion of the reception process, step S16 is carried out to send an acknowledgement from the receiving device to the transmitting device.

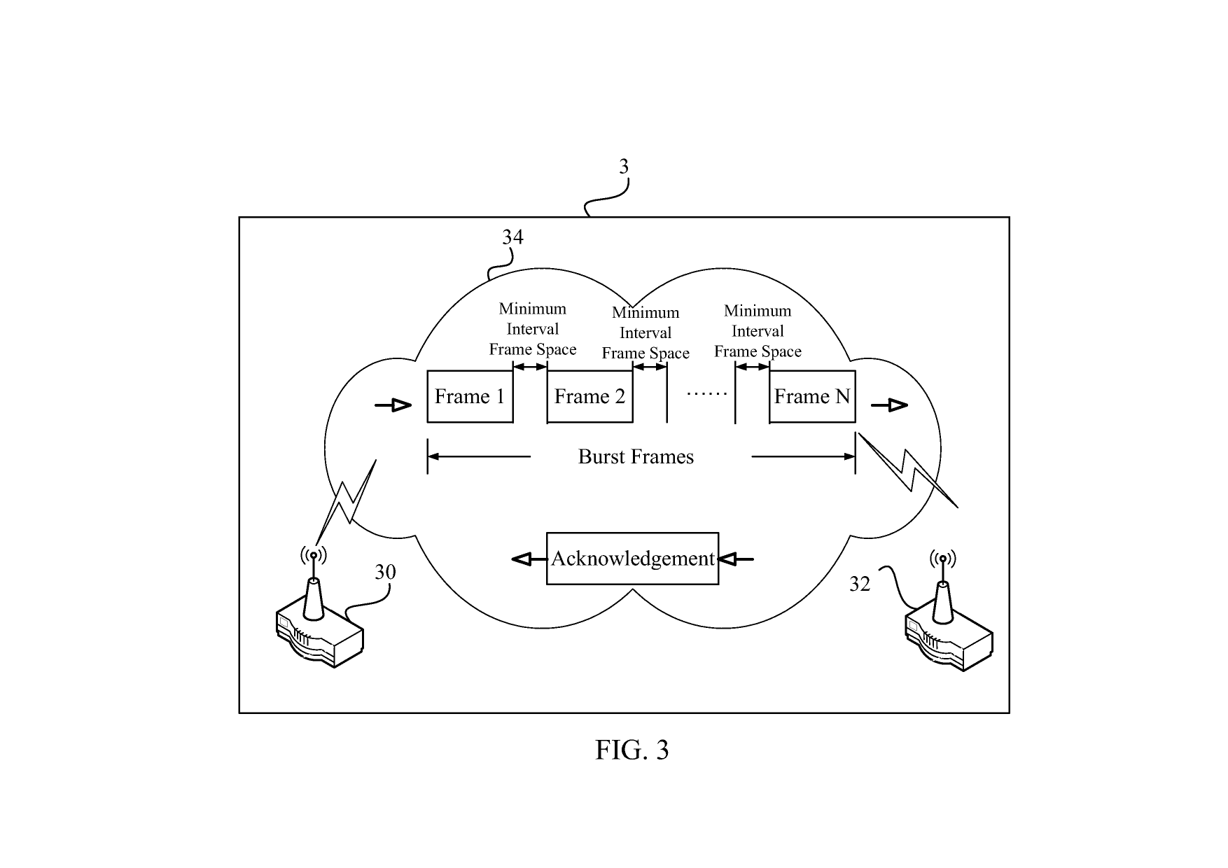

Referring to FIG. 3, FIG. 3 is a schematic diagram illustrating the communication system, according to another preferred embodiment of the invention, for adjusting the number of burst frames. The communication system comprises a transmitting device for transmitting a predetermined number of burst frames and a receiving device for receiving them. A parameter associated with the frames received is calculated during the reception of the burst frames, and an acknowledgement is sent to the transmitting device upon completion of reception, for adjusting the predetermined number according to the parameter.

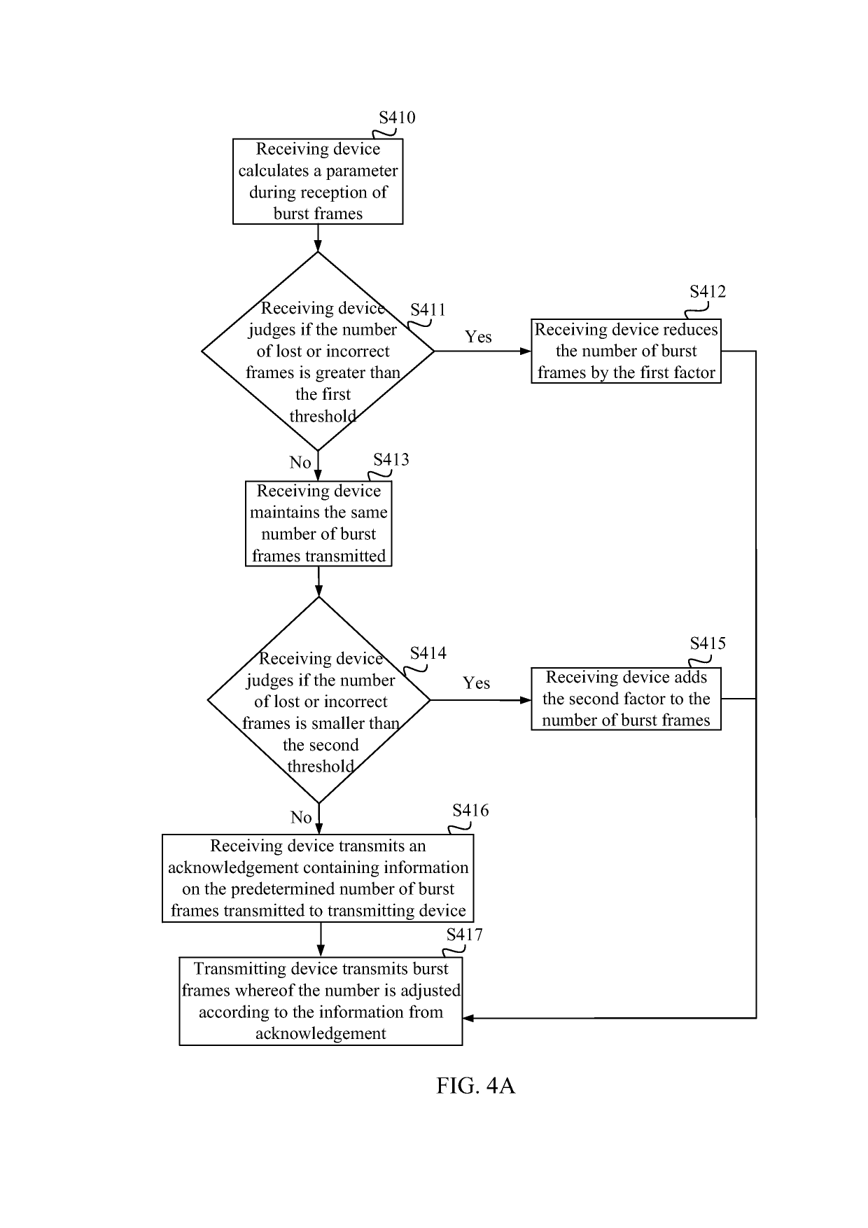

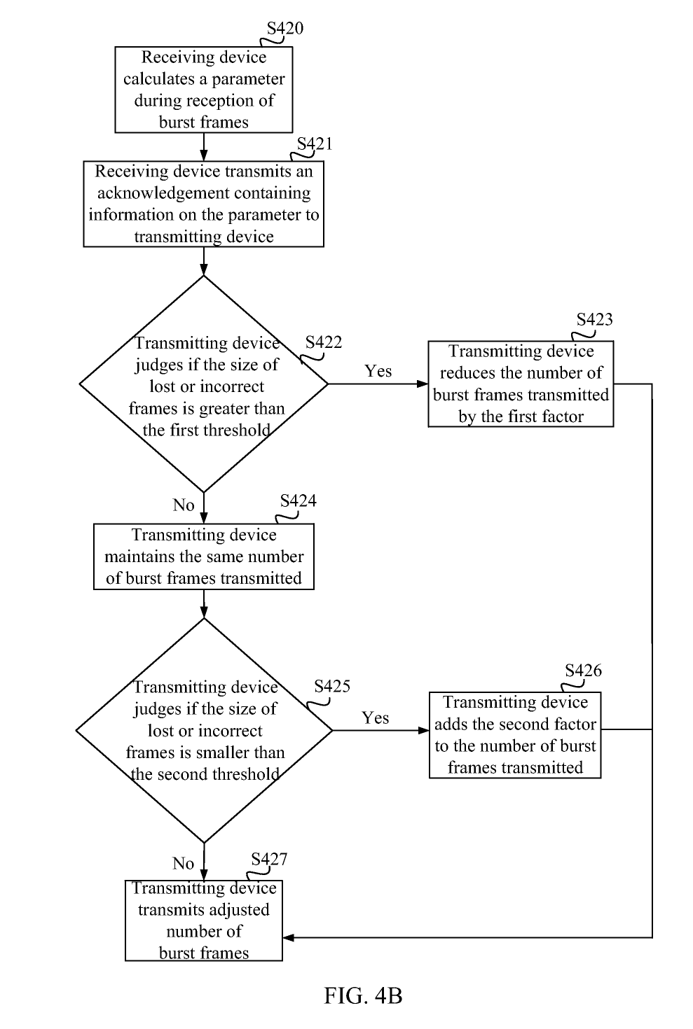

Referring to FIGS. 4A and 4B, FIGS. 4A and 4B are flowcharts showing the operating flow of the adjustment of the number of burst frames in the communication system. In FIG. 4A, step S40 is carried out to calculate a parameter associated with the frames received during reception.

In another embodiment of the method, the parameter is associated with the number of lost frames among the burst frames received.

In another embodiment of the method, the parameter is associated with the number of incorrect frames among the received ones.

In another embodiment of the method, the receiving device has a buffer for storing frames not received in order, and the parameter is associated with number of frames stored.

Following step S40, step S41 is carried out to judge whether the number of lost or incorrect frames in the parameter is greater than the first threshold. If the comparison result shows that the parameter is greater, step S42 is performed to reduce the predetermined number of burst frames by the first factor; otherwise, step S43 is performed to maintain the same number. Step S44 is performed after step S43 to judge whether the number of lost or incorrect frames in the parameter is smaller than the second threshold. Step S45 is carried out to add the second factor to the predetermined number if comparison result indicates a relatively smaller parameter value.

Upon completion of the reception of frames, step S46 is carried out to transmit an acknowledgment with information pertaining to the adjusted number of burst frames from the receiving device to the transmitting device. Finally, step S47 is performed such that the transmitting device transmits the adjusted number of burst frames in accordance with information from the acknowledgement.

Referring to FIG. 4B, first, step S50 is carried out to calculate a parameter associated with the frames received during reception. Step S51 is carried out upon completion of reception to transmit from the receiving device an acknowledgment with information pertaining to the adjusted number of burst frames to the transmitting device.

In another embodiment of the method, the parameter is associated with the number of lost frames among the burst frames received.

In another embodiment of the method, the parameter is associated with the number incorrect frames among the ones received.

In another embodiment of the method, the receiving device has a buffer for storing frames not received in order, and the parameter is associated with number of frames stored.

Following step S51, step S52 is carried out to judge whether the number of lost or incorrect frames in the parameter is greater than the first threshold. If the comparison result shows that the parameter is greater than the first threshold, step S53 is performed to reduce the predetermined number by the first factor; otherwise, step S54 is performed to maintain the same number. Step S55 is conducted to judge, by the transmission device, whether the number of lost or incorrect frames in the parameter is smaller than the second threshold, and the second factor is added to the predetermined number if the comparison result indicates an equal or smaller parameter value to the second threshold in the next step S56. Upon completion of the reception process, step S57 is carried out such that the transmitting device transmits the adjusted number of burst frames according to the information from the acknowledgement.

Therefore, the method and the system for adjusting burst frames thereof can dynamically adjust the number of burst frames transmitted, thereby reducing the number of retransmissions of previously incorrectly received frames, so as to increase the usage rate of transmission channel and to improve efficiency of communication system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for adjusting a predetermined number of burst frames transmitted through a channel from a transmitting device to a receiving device, the method comprising the steps of:
calculating, during reception of the burst frames, a parameter associated with the burst frames received;
comparing the parameter with a first threshold; and
adjusting the predetermined number of the burst frames in accordance with the comparison result.

2. The method of claim 1, further comprising the step of:
reducing the number of the burst frames by a first value if the parameter is greater than the first threshold.

3. The method of claim 2, further comprising the step of:
maintaining the same number of the burst frames if the parameter is equal to or smaller than the first threshold.

4. The method of claim 2, further comprising the steps of:
comparing the parameter with a second threshold; and
adding a second factor to the predetermined number of the burst frames if the parameter is smaller than the second threshold.

5. The method of claim 1, wherein the parameter is associated with the number of frames lost during transmission the predetermined number of the burst frames.

6. The method of claim 1, wherein the parameter is associated with a number of incorrect received frames among the predetermined number of the burst frames.

7. The method of claim 1, wherein the receiving device has a buffer for storing frames not received in order, and the parameter is associated with number of frames stored.

8. The method of claim 1, wherein an acknowledgement is sent from the receiving device to the transmitting device after receiving the predetermined number of the burst frames.

9. A communication system, further comprising:
a transmitting device for transmitting a predetermined number of burst frames; and
a receiving device for receiving the predetermined number of the burst frames transmitted and calculating, during the reception of the burst frames, a parameter associated with the frames received, and sending out an acknowledgment to the transmitting device upon completion of the reception process;
wherein the predetermined number will be adjusted in accordance with the parameter.

10. The communication system of claim 9, wherein the receiving device compares the parameter with a first threshold and adjusts the predetermined number in accordance with the comparison result.

11. The communication system of claim 10, wherein the receiving device reduces the predetermined number by a first value if the parameter is greater than the first threshold.

12. The communication system of claim 10, wherein the receiving device maintains the same number of burst frames if the parameter is equal to or smaller than a first threshold.

13. The communication system of claim 10, wherein the receiving device compares the parameter with a second threshold and adds a second value to the predetermined number if the parameter is smaller than the second threshold.

14. The communication system of claim 9, wherein the parameter is associated with the number of the burst frames lost among the received burst frames.

15. The communication system of claim 9, wherein the parameter is associated with the number of incorrect frames among the predetermined number of the burst frames.

16. The communication system of claim 9, the receiving device further comprising:
a buffer for storing frames not in sequence, and the parameter is associated with the number of frames stored in the buffer.

17. The communication system of claim 9, wherein the acknowledgement comprises the parameter.

18. The communication system of claim 17, wherein the receiving device compares the parameter with the first threshold and adjusts the predetermined number in accordance with the comparison result.

19. The communication system of claim 17, wherein the receiving device maintains the same number of burst frames if the parameter is equal to or smaller than the first threshold.

20. The communication system of claim 17, wherein the receiving device compares the parameter with the second threshold and adds the second value to the predetermined number if the parameter is smaller.
